(19) United States
(12) Patent Application Publication
(10) Pub. No.: US 2025/0330946 A1
(43) Pub. Date: Oct. 23, 2025

(54) METHOD AND DEVICE FOR HYBRID RANGING USING UWB COMMUNICATION

(71) Applicant: Samsung Electronics Co., Ltd., Suwon-si (KR)

(72) Inventors: Jinwook SEO, Suwon-si (KR); Joohyun LEE, Suwon-si (KR); Junyoung CHOI, Suwon-si (KR)

(21) Appl. No.: 19/185,930

(22) Filed: Apr. 22, 2025

(30) Foreign Application Priority Data
Apr. 22, 2024 (KR) 10-2024-0053650

(51) Int. Cl. H04W 64/00; H04B 1/7163; H04W 48/20; H04W 74/04

(52) U.S. Cl. CPC H04W 64/00; H04W 48/20; H04W 74/04; H04B 1/7163

(57) ABSTRACT

According to an embodiment of the present disclosure, an operation method of an ultra wide band (UWB) device includes: in a session for downlink time difference of arrival (DL-TDoA), receiving a DL-TDoA message from an anchor; performing contention-based ranging (CBR) to select a gate for performing UWB ranging between a first HUS (hybrid UWB session) of a first gate and a second HUS of a second gate; selecting the second gate as the gate to perform the UWB ranging based on the CBR result; and performing two-way ranging (TWR) with the second gate in the second HUS of the second gate. The first secondary phases within the first primary session of the first HUS may be scheduled not to overlap, in terms of time intervals, with the second secondary phases within the second primary session of the second HUS.

### CROSS-REFERENCE TO RELATED APPLICATION(S)

This application is based on and claims priority under 35 U.S.C. § 119 (a) of a Korean patent application number 10-2024-0053650, filed on Apr. 22, 2024, in the Korean Intellectual Property Office, the disclosure of which is incorporated by reference herein in its entirety.

### BACKGROUND

### 1. Field

The disclosure relates to an ultra wideband (UWB) communication. More particularly, the disclosure relates to a hybrid ranging method and device using UWB communication.

### 2. Description of Related Art

The Internet is evolving from the human-centered connection network by which humans create and consume information to the Internet of things (IoT) network by which information is communicated and processed between things or other distributed components. Another arising technology is the Internet of everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet technology (IT) services that collect and analyze the data generated by the things connected with one another to create human life a new value. The IoT may have various applications, such as a smart home, a smart building, a smart city, a smart car or a connected car, a smart grid, health-care, or smart appliance industry, or state-of-art medical services, through conversion or integration of information technology (IT) techniques and various industries.

As wireless communication systems evolve to provide various services, a need arises for a method for effectively providing such services. For example, it is possible to use a ranging technique for measuring the distance between electronic devices using ultra wide band (UWB). UWB is a wireless communication technology that uses a very wide frequency band of several GHz or more in a baseband without using a wireless carrier.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for efficiently utilizing a ranging resource by performing hybrid ranging in an ultra wide band (UWB)-based gate system.

Additional aspects will be set forth in part in the description which follows and, in part, will be apparent from the description, or may be learned by practice of the presented embodiments.

In accordance with an aspect of the disclosure, an ultra wide band (UWB) device is provided. The UWB includes a UWB subsystem (UWBS) and a processor connected to the UWBS. The processor may control utilizing a ranging resource by performing hybrid ranging in an UWB-based gate system.

According to an embodiment of the present disclosure, an operation method of an ultra wide band (UWB) device includes: in a session for downlink time difference of arrival (DL-TDoA), receiving a DL-TDoA message from an anchor; performing contention-based ranging (CBR) to select a gate for performing UWB ranging between a first HUS (hybrid UWB session) of a first gate and a second HUS of a second gate; selecting the second gate as the gate to perform the UWB ranging based on the CBR result; and performing two-way ranging (TWR) with the second gate in the second HUS of the second gate. The first secondary phases within the first primary session of the first HUS may be scheduled not to overlap, in terms of time intervals, with the second secondary phases within the second primary session of the second HUS.

The UWB device according to an embodiment of the disclosure may efficiently utilize a ranging resource by performing hybrid ranging.

Further, the UWB device according to an embodiment of the disclosure may efficiently manage service time by performing hybrid ranging.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an architecture of a UWB device according to an embodiment of the disclosure;

FIG. 2 illustrates a configuration of a framework of a UWB device according to an embodiment of the disclosure;

FIG. 3 illustrates a method illustrating communication by a plurality of electronic devices according to an embodiment of the disclosure;

FIG. 4 illustrates a structure of a UWB medium access control (MAC) frame according to an embodiment of the disclosure;

FIGS. 5A and 5B illustrate a structure of a UWB physical (PHY) packet according to various embodiments of the disclosure;

FIG. 6 illustrates a structure of a ranging block and round used for UWB ranging according to an embodiment of the disclosure;

FIGS. 7A, 7B, and 7C illustrate a UWB session configurations according to various embodiments of the disclosure;

FIG. 8 illustrates a diagram illustrating a downlink-time difference of arrival (DL-TDoA) session and a hybrid UWB session according to an embodiment of the disclosure;

FIG. 9 illustrates a hybrid UWB session configuration according to an embodiment of the disclosure;

FIG. 10 illustrates a diagram illustrating a possibility of interference occurrence according to a multi-session configuration according to an embodiment of the disclosure;

FIG. 11 illustrates UWB devices configure a multi-session according to an embodiment of the disclosure;

FIG. 12 illustrates UWB devices configure a multi-session according to an embodiment of the disclosure;

FIG. 13 illustrates a diagram illustrating a timing estimation algorithm according to an embodiment of the disclosure;

FIG. 14 illustrates UWB devices configure a multi-session according to an embodiment of the disclosure;

FIG. 15 illustrates UWB devices configure a multi-session according to an embodiment of the disclosure;

FIG. 16 illustrates illustrating UWB devices configure a multi-session according to an embodiment of the disclosure;

FIG. 17 illustrates UWB devices configure a multi-session according to an embodiment of the disclosure;

FIGS. 18, 19, 20, and 21 illustrate block-wise session and phase configuration variations in a UWB tagless gate scenario according to various embodiments of the disclosure;

FIG. 22 illustrates a flowchart illustrating an operation of a UWB device according to an embodiment of the disclosure; and

FIG. 23 illustrates a structure of a UWB device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

In describing embodiments of the disclosure, the description of technologies that are known in the art and are not directly related to the disclosure is omitted. This is for further clarifying the gist of the disclosure without making it unclear.

For the same reasons, some elements may be exaggerated or schematically shown. The size of each element does not necessarily reflect the real size of the element. The same reference numeral is used to refer to the same element throughout the drawings.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments of the disclosure, the functions mentioned in the blocks may occur in different orders. For example, two blocks that are consecutively shown may be performed substantially simultaneously or in a reverse order depending on corresponding functions.

As used herein, the term “unit” means a software element or a hardware element, such as a field-programmable gate array (FPGA) or an application specific integrated circuit (A SIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments of the disclosure, a “ . . . unit” may include one or more processors.

As used herein, the term ‘terminal’ or ‘device’ may also be referred to as a mobile station (MS), a user equipment (UE), a user terminal (UT), a terminal, a wireless terminal, a access terminal (AT), a subscriber unit, a subscriber station (SS), a wireless device, a wireless communication device, a wireless transmit/receive unit (WTRU), a mobile node, or a mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In an embodiment of the disclosure, the terminal may be referred to as an electronic device or simply as a device.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the disclosure and may be replaced with other terms according to the intention or practice of the user or operator. Therefore, the terms should be defined based on the overall disclosure.

Hereinafter, embodiments of the disclosure are described with reference to the accompanying drawings. Further, although a communication system using UWB is described in connection with embodiments of the disclosure, as an example, embodiments of the disclosure may also apply to other communication systems with similar technical background or features. For example, a communication system using Bluetooth or ZigBee may be included therein. Further, embodiments of the disclosure may be modified in such a range as not to significantly depart from the scope of the disclosure under the determination by one of ordinary skill in the art and such modifications may be applicable to other communication systems.

When determined to make the subject matter of the disclosure unclear, the detailed description of the known art or functions may be skipped. The terms as used herein are defined considering the functions in the disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on institute of electrical and electronics engineers (IEEE) 802.11 which enables access to the backbone network within a radius of about 100 m. WPAN is a technology based on IEEE 802.15 which includes Bluetooth, ZigBee, and ultra wide band (UWB). A wireless network in which such a wireless network technology is implemented may include a plurality of electronic devices.

UWB may refer to a short-range high-rate wireless communication technology using a wide frequency band of several GHz or more, low spectral density, and short pulse width (e.g., 1 nsec to 4 nsec) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

According to the definitions by the federal communications commission (FCC), UWB may refer to a wireless communication technology that uses a bandwidth of 500 MHz or more or a bandwidth corresponding to a center frequency of 20% or more. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

“Application dedicated file (ADF)” may be, e.g., a data structure in an application data structure that may host an application or application specific data.

“Application protocol data unit (APDU)” may be a command and a response used when communicating with the application data structure in the UWB device.

“Application specific data” may be, e.g., a file structure having a root level and an application level including UWB controlee information and UWB session data required for a UWB session.

“Controller” may be a ranging device that defines and controls ranging control messages (RCM) (or control messages).

“Controlee” may be a ranging device using a ranging parameter in the RCM (or control message) received from the controller.

Unlike “static STS,” “dynamic scrambled timestamp sequence (STS) mode” may be an operation mode in which the STS is not repeated during a ranging session. In this mode, the STS may be managed by the ranging device, and the ranging session key that generates STS may be managed by a secure component.

“Applet” may be, e.g., an applet executed on the secure component including UWB parameters and service data. In an embodiment of the disclosure, Applet may be a FiR a Applet defined by FiRa.

“Ranging device” may be a device capable of performing UWB ranging. In an embodiment of the disclosure, the ranging device may be an enhanced ranging device (ERDEV) defined in IEEE 802.15.4z or a FiRa device defined by FiRa. The ranging device may be referred to as a UWB device.

“UWB-enabled Application” may be an application for UWB service. For example, the UWB-enabled Application may be an application using a framework application programming interface (API) for configuring an out-of-band (OOB) connector, a secure service, and/or a UWB service for a UWB session. In an embodiment of the disclosure, “UWB-enabled Application” may be abbreviated as an application or a UWB application. UWB-enabled Application may be a FiRa-enabled application defined by FiR a.

“Framework” may be a component that provides access to Profiles, individual-UWB configuration and/or notifications. “Framework” may be, e.g., a collection of logical software components including profile manager, OOB connector, secure service, and/or UWB service. In an embodiment of the disclosure, the framework may be a FiR a framework defined by FiRa.

“OOB connector” may be a software component for establishing an out-of-band (OOB) connection (e.g., Bluetooth low energy (BLE) connection) between ranging devices. In an embodiment of the disclosure, the OOB Connector may be a FiR a OOB Connector defined by FiRa.

“Profile” may be a previously defined set of UWB and OOB configuration parameters. In an embodiment of the disclosure, Profile may be a FiR a Profile defined by FiRa.

“Profile manager” may be a software component that implements a profile available on the ranging device. In an embodiment of the disclosure, the profile manager may be a FiRa profile manager defined by FiRa.

“Service” may be an implementation of a use case that provides a service to an end-user.

“Smart ranging device” may be a ranging device that may implement an optional framework API. In an embodiment of the disclosure, the smart ranging device may be a FiRa smart device defined by FiR a.

“Global dedicated file (GDF)” may be a root level of application specific data including data required to establish a USB session.

“Framework API” may be an API used by a UWB-enabled application to communicate with the Framework.

“Initiator” may be a ranging device that initiates a ranging exchange.

“object identifier (OID)” may be an identifier of the ADF in the application data structure.

“Out-of-band (OOB)” may be data communication that does not use UWB as an underlying wireless technology.

“Ranging data set (RDS)” may be data (e.g., UWB session key, session ID, or the like) required to establish a UWB session when it is needed to protect confidentiality, authenticity and integrity.

“Responder” may be a ranging device that responds to the initiator in a ranging exchange.

“STS” may be a ciphered sequence for increasing the integrity and accuracy of ranging measurement timestamps. The STS may be generated from the ranging session key.

“Secure channel” may be a data channel that prevents overhearing and tampering.

“Secure component” may be an entity (e.g., SE or TEE) having a defined security level that interfaces with UWBS for the purpose of providing RDS to UWBS, e.g., when dynamic STS is used.

“Secure element (SE)” may be a tamper-resistant secure hardware component that may be used as a secure component in the ranging device.

“Secure ranging” may be ranging based on STS generated through a strong encryption operation.

“Secure service” may be a software component for interfacing with a secure component, such as a secure element or trusted execution environment (TEE).

“Service applet” may be an applet on a secure component that handles service specific transactions.

“Service data” may be data defined by a service provider that needs to be transferred between two ranging devices to implement a service.

“Service provider” may be an entity that defines and provides hardware and software required to provide a specific service to an end-user.

“Static STS mode” is an operation mode in which STS is repeated during a session, and does not need to be managed by the secure component.

“Secure UWB Service (SUS) Applet” may be an applet on the SE that communicates with the applet to retrieve data needed to enable secure UWB sessions with other ranging devices. The SUS applet may transfer corresponding data (information) to the UWBS.

“UWB service” may be a software component that provides access to the UWBS.

“UWB session” may be a period from when the controller and the controllee start communication through UWB until the communication stops. A UWB Session may include ranging, data transfer, or both ranging and data transfer.

“UWB session ID” may be an ID (e.g., a 32-bit integer) that identifies the UWB Session, shared between the controller and the controller.

“UWB session key” may be a key used to protect the UWB Session. The UWB session key may be used to generate the STS. In an embodiment of the disclosure, the UWB session key may be a UWB ranging session key (URSK), and may be abbreviated as a session key.

“UWB subsystem (UWBS)” may be a hardware component implementing the UWB PHY and MAC layers specifications. UWBS may have an interface to Framework and an interface to secure component to search for RDS. In an embodiment of the disclosure, the UWB PHY and MAC specifications may be, e.g., FiRa PHY and FiRa MAC specifications defined by FiR a referring to IEEE 802.15.4/4z.

“One-way ranging (OWR)” may be a ranging scheme using a time difference of arrival (TDoA) localization method. The TDoA method corresponds to a method for locating a mobile device based on a relative arrival time of a single message or multiple messages. For a description of OWR (TDoA), reference may be made to the description of IEEE 802.15.4z. As an example of the OWR scheme, a downlink (DL)-TDoA scheme may be included.

“DL-TDoA (DT)” may be a localization method using TDoA measurement from a plurality of DT-anchors. As an embodiment of the disclosure, the DT-anchors may exchange DT messages (DTMs) (ranging messages) with each other, and the DT-tag may passively receive the DTM. As an embodiment of the disclosure, each DT-tag receiving DTMs may calculate the TDoA using at least one of the reception timestamp of each DTM, the transmission timestamp of DTMs included in the corresponding DTMs, or the reply time included in the DTMs. As an embodiment of the disclosure, the DT-tag may estimate its location based on at least one of the calculated coordinates of TDoA and DT-anchors.

“Two-way ranging (TWR)” may be a ranging scheme capable of estimating a relative distance between two devices by measuring time of flight (ToF) through the exchange of ranging messages between the two devices. The TWR scheme may be one of double-sided two-way ranging (DS-TWR) and single-sided two-way ranging (SS-TWR). SS-TWR may be a procedure for performing ranging through one round-trip time measurement. DS-TWR may be a procedure for performing ranging through two round-trip time measurements. For a description of SS-TWR and DS-TWR, reference may be made to the description of IEEE 802.15.4z.

“UWB message” may be a message including a payload IE transmitted by the UWB device (e.g., ERDEV).

The “ranging message” may be a message transmitted by a UWB device (e.g., ERDEV) in a UWB ranging procedure. For example, the ranging message may be a message, such as a ranging initiation message (RIM), a ranging response message (RRM), a ranging final message (RFM), or a measurement report message (MRM), transmitted by a UWB device (e.g., ERDEV) in a specific phase of the ranging round. A ranging message may include one or more UWB messages. If necessary, a plurality of ranging messages may be merged into one message. For example, in the case of non-deferred DS-TWR ranging, RFM and MRM may be merged into one message in a ranging final phase.

“UWB channel” may be one of candidate UWB channels allocated for UWB communication. Candidate UWB channels allocated for UWB communication may be channels allocated for UWB communication defined in IEEE 802.15.4/4z. The UWB channel may be used for UWB ranging and/or transaction. For example, the UWB channel may be used for transmission/reception of a ranging frame RFRAME and/or transmission/reception of a data frame.

“Narrow band (NB) channel” may be a channel having a narrower bandwidth than the UWB channel. The NB channel may be a subchannel of one of the candidate UWB channels allocated for UWB communication. Candidate UWB channels allocated for UWB communication may be channels allocated for UWB communication defined in IEEE 802.15.4/4z. The NB channel may be used for advertising, device discovery, and/or connection setup for additional parameter negotiation/authentication. For example, the NB channel may be used for transmission and reception of an advertisement message, an additional advertising message, a connection request message, and/or a connection confirmation message.

When determined to make the subject matter of the disclosure unnecessarily unclear, the detailed description of related known functions or features may be skipped in describing the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, various embodiments of the disclosure are described with reference to the accompanying drawings.

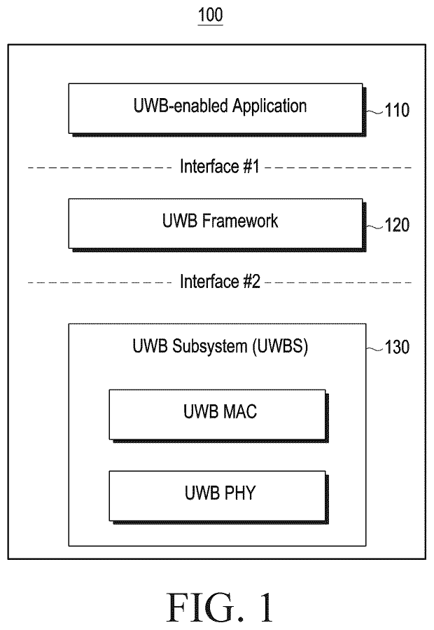

FIG. 1 illustrates an architecture of a UWB device according to an embodiment of the disclosure.

In an embodiment of the disclosure, a UWB device 100 may be an electronic device supporting UWB communication. The UWB device 100 may be, e.g., a ranging device supporting UWB ranging. In an embodiment of the disclosure, the ranging device may be an ERDEV or a FiRa device.

Referring to FIG. 1, the UWB device 100 may interact with other UWB devices through a UWB session.

The UWB device 100 may implement a first interface (Interface #1) that is an interface between a UWB-enabled Application 110 and a Framework 120, and the first interface allows the UWB-enabled Application 110 on the UWB device 100 to use the UWB capabilities of the UWB device 100 in a predetermined manner. In an embodiment of the disclosure, the first interface may be a Framework API or a proprietary interface, but is not limited thereto.

The UWB device 100 may implement a second interface (Interface #2) that is an interface between the UWB-enabled Application 110 and a UWB subsystem (UWBS, 130). In an embodiment of the disclosure, the second interface may be a UWB command interface (UCI) or proprietary interface, but is not limited thereto.

Referring to FIG. 1, the UWB device 100 may include a UWB-enabled Application 110, a Framework (UWB Framework) 120, and/or a UWBS 130 including a UWB MAC Layer and a UWB Physical Layer. Depending on the embodiment of the disclosure, some entities may not be included in the UWB device, or additional entities (e.g., security layer) may be further included.

The UWB-enabled Application 110 may trigger establishment of a UWB session by a UWBS 130 through the first interface. The UWB-enabled Application 110 may use one of previously defined profiles (profile). For example, the UWB-enabled Application 110 may use one of the profiles defined in FiRa or a custom profile. The UWB-enabled Application 110 may use the first interface to handle related events, such as service discovery, ranging notifications, and/or error conditions.

The Framework 120 may provide access to Profiles, individual-UWB configuration and/or notifications. The Framework 120 may support at least one of a function for UWB ranging and transaction execution, a function to provide an interface to the application and UWBS 130, or a function to estimate the location of the UWB device 100. The Framework 120 may be a set of software components. As described above, the UWB-enabled Application 110 may interface with the Framework 120 through the first interface, and the Framework 120 may interface with the UWBS 130 through the second interface.

Meanwhile, in an embodiment of the disclosure, the UWB-enabled Application 110 and/or Framework 120 may be implemented by an application processor (AP) (or processor). Accordingly, in an embodiment of the disclosure, the operation of the UWB-enabled Application 110 and/or the Framework 120 may be understood as performed by an AP (or a processor). In an embodiment of the disclosure, the framework may be referred to as an AP or a processor.

The UWBS 130 may be a hardware component including a UWB MAC layer and a UWB physical layer. The UWBS 130 may perform UWB session management and may communicate with the UWBS of another UWB device. The UWBS 130 may interface with the Framework 120 through the second interface and may obtain the secure data from the secure component. In an embodiment of the disclosure, the framework (or application processor) 120 may transmit a command to the UWBS 130 through UCI, and the UWBS 130 may transmit a response to the command to the Framework 120. The UWBS 130 may transfer a notification to the Framework 120 through the UCI.

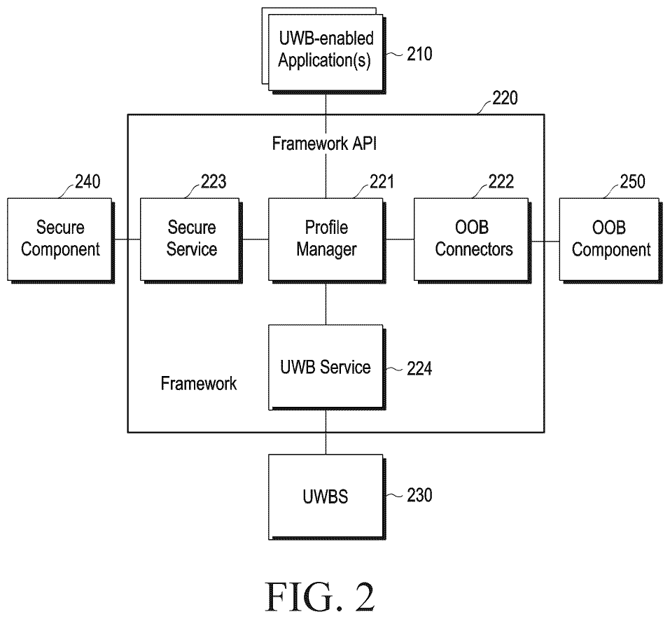

FIG. 2 illustrates a configuration of a framework of a UWB device according to an embodiment of the disclosure.

The UWB device of FIG. 2 may be an example of the UWB device of FIG. 1.

Referring to FIG. 2, a Framework 220 may include, e.g., software components, such as a Profile Manager 221, an OOB Connector(s) 222, a Secure Service 223 and/or a UWB service 224.

The Profile Manager 221 may serve to manage profiles available on the UWB device. Profile may be a set of parameters required to establish communication between UWB devices. For example, a profile may include a parameter indicating which OOB secure channel is used, a UWB/OOB configuration parameter, a parameter indicating whether the use of a particular secure component is mandatory, and/or a parameter related to the file structure of the ADF. A UWB-enabled application 210 may communicate with the Profile Manager 221 through the first interface (e.g., framework (API)).

The OOB Connector 222 may serve to establish an OOB connection with another device. The OOB Connector 222 may handle an OOB step including a discovery step and/or a connection step. The OOB component (e.g., BLE component) 250 may be connected to the OOB connector 222.

The Secure Service 223 may play a role of interfacing with a Secure Component 240, such as SE or TEE.

The UWB Service 224 may perform a role of managing the UWBS 230. The UWB Service 224 may provide access to the UWBS 230 from the Profile Manager 221 by implementing the second interface.

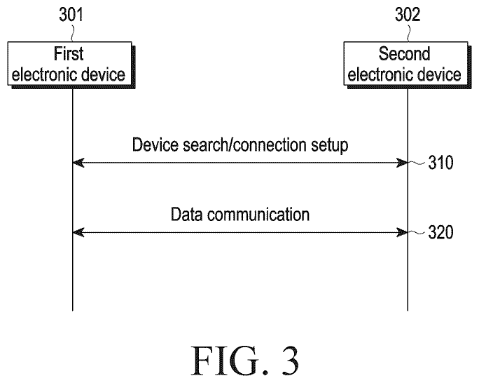

FIG. 3 illustrates a method for performing communication by a plurality of electronic devices according to an embodiment of the disclosure.

Referring to FIG. 3, a first electronic device 301 and a second electronic device 302 of FIG. 3 may be, e.g., the UWB devices of FIG. 1 or 2.

The first electronic device 301 and the second electronic device 302 may perform a device search/connection setup procedure 310 and a data communication procedure 320. The device search/connection setup procedure 310 and data communication procedure 320 may be managed or controlled by the MAC layer (entity) of the electronic device.

### Device Search/Connection Setup Procedure

In an embodiment of the disclosure, the device search/connection setup procedure 310 may be a prior procedure performed before the data communication procedure 320. As an example, the device discovery/connection setup procedure 310 may be performed over OOB communication (channel) and/or UWB communication (channel).

The device search/connection setup procedure 310 may include at least one of the following operations.

Device discovery operation: an operation in which the electronic device searches for (discovers) another UWB devices. The device discovery operation may include an operation for transmitting/receiving an advertisement message. In an embodiment of the disclosure, the device discovery operation may be referred to as a discovery operation or an advertising operation.

Connection setup operation: an operation in which two electronic devices establish a connection. The connection setup operation may include an operation for transmitting/receiving a connection request message and a connection confirmation message. A connection (channel) established through the connection setup operation may be used to configure and control a UWB session for data communication. For example, parameters (e.g., UWB performance parameters (controllee performance parameters), UWB configuration parameters, session key-related parameters) for configuring a UWB session through a secure channel established through the connection setup operation may be negotiated between two electronic devices.

### Data Communication Procedure

In an embodiment of the disclosure, the data communication procedure 320 may be a procedure for transmitting and receiving data using UWB communication. As an embodiment of the disclosure, the data communication procedure may be performed by UWB communication or NB communication.

The data communication procedure 320 may include at least one of the following operations.

UWB ranging operation: an operation in which the electronic device performs UWB ranging with another electronic device in a preset UWB ranging scheme (e.g., OWR, SS-TWR, DS-TWR scheme). As an embodiment of the disclosure, the UWB ranging operation may include a ToF measurement operation and/or an AoA measurement operation.

For example, a DS-TWR scheme may include some or all of the following phases:

Ranging control phase (RCP): a phase in which the UWB controller transmits a UWB control message (e.g., ranging control message (RCM)) to the UWB controlee. This allows the controller to control ranging and define ranging parameters.

Ranging initiation phase (RIP): a phase in which the UWB initiator transmits a UWB initiation message (e.g., ranging initiation message (RIM)) to the UWB responder. The ranging initiation message may be a first message transmitted to initiate ranging exchange. As an embodiment of the disclosure, the UWB controller/initiator may transmit a ranging control message and a ranging initiation message through one message. For example, the UWB controller/initiator may transmit a ranging initiation message that includes a ranging control message.

Ranging response phase (RRP): a phase in which the UWB responder transmits a UWB response message (e.g., a ranging response message (RRM)) to the UWB initiator corresponding to the UWB initiation message.

Ranging final phase (RFP): a phase in which the UWB initiator transmits a UWB final message (e.g., a ranging final message (RFM)) to the UWB responder. The RFP may be used only in the case of double-sided two-way ranging (DS-TWR).

As an embodiment of the disclosure, the UWB TWR procedure may further include a measurement report phase (MRP). The measurement report phase may be a phase in which electronic devices participating in UWB ranging exchange ranging information (e.g., ToF information/AoA information) and/or related service information. As an embodiment of the disclosure, the UWB message used in the measurement report phase may be a measurement report message (MRM), a ranging result report message (RRRM), or a control update message (CUM). As an embodiment of the disclosure, the MRM may be included and transmitted in the RRM or RFM.

Transaction operation: an operation in which an electronic device exchanges service data with another electronic device.

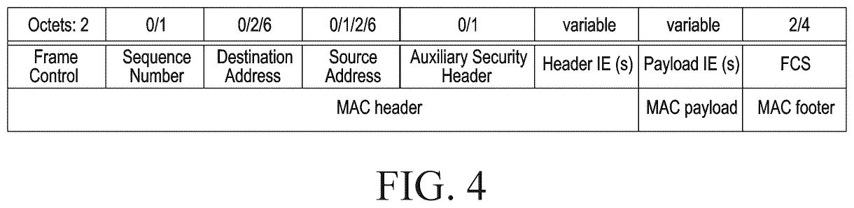

FIG. 4 illustrates a structure of a UWB MAC frame according to an embodiment of the disclosure.

Referring to FIG. 4, the UWB MAC frame may follow the MAC frame structure of IEEE 802.15.4z, for example. In an embodiment of the disclosure, the UWB MAC frame may be simply referred to as a MAC frame or frame. As an embodiment of the disclosure, the UWB MAC frame may be used to transfer UWB data (e.g., UWB message, ranging message, control information, service data, application data, transaction data, or the like).

Referring to FIG. 4, the UWB MAC frame may include a MAC header (MHR), a MAC payload and/or a MAC footer (MFR).

### MAC Header

The MAC header may include a frame control field, a sequence number field, a destination address field, a source address field, an auxiliary security header field, and/or at least one header IE field. According to an embodiment of the disclosure, some fields may not be included in the MAC header.

As an embodiment of the disclosure, the frame control field may include a frame type field, a security enabled field, a frame pending field, an AR field, a PAN ID compression field, a sequence number suppression field, an IE present field, a destination addressing mode field, a frame version field, and/or a source addressing mode field. Each field is described below.

The frame type field may indicate the frame type. As an embodiment of the disclosure, the frame type may include a data type and/or a multipurpose type.

The security enabled field may indicate whether an auxiliary security header field exists. The auxiliary security header field may include information required for security processing.

The frame pending field may indicate whether the device transmitting the frame has more data for the recipient. In other words, the frame pending field may indicate whether there is a pending frame for the recipient.

The AR field may indicate whether acknowledgment for frame reception is required from the recipient.

The PAN ID compression field may indicate whether the PAN ID field exists.

The sequence number suppression field may indicate whether the sequence number field exists. The sequence number field may indicate the sequence identifier for the frame.

The IE Present field may indicate whether the header IE field and the payload IE field are included in the frame.

The destination addressing mode field may indicate whether the destination address field may include a short address (e.g., 16 bits) or an extended address (e.g., 64 bits). The destination address field may indicate the address of the recipient of the frame.

The frame version field may indicate the frame version. For example, the frame version field may be set to a value indicating IEEE std 802.15.4z-2020.

The source addressing mode field may indicate whether the source address field exists, and if the source address field exists, whether the source address field includes a short address (e.g., 16 bits) or an extended address (e.g., 64 bits). The source address field may indicate the address of the originator of the frame.

### MAC Payload

The MAC payload may include at least one Payload IE field. As an embodiment of the disclosure, the Payload IE field may include a vendor specific nested IE. As an embodiment of the disclosure, the Payload IE field may include the Payload IE field of the UWB message, ranging message or control message.

### MAC Footer

The MAC footer may include an FCS field. The FCS field may include a 16-bit CRC or a 32-bit CRC.

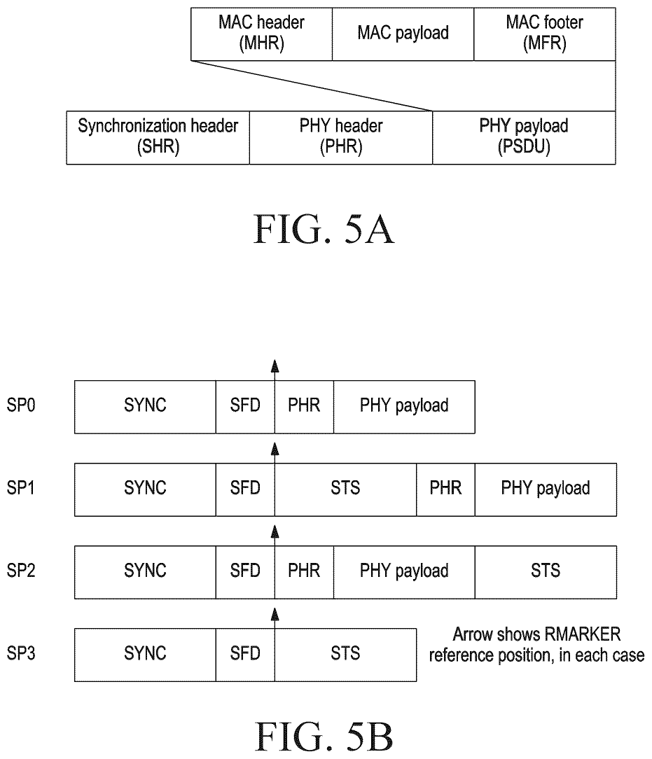

FIGS. 5A and 5B illustrate a structure of a UWB PHY packet according to various embodiments of the disclosure.

FIG. 5A illustrates a structure of a UWB PHY packet to which the STS packet configuration is not applied, and FIG. 5B illustrates a structure of a UWB PHY packet to which the STS packet configuration is applied. In an embodiment of the disclosure, the UWB PHY packet may be referred to as a PHY packet, a PHY PDU (PPDU), or a frame.

Referring to FIG. 5A, the PPDU may include a synchronization header (SHR), a PHY header (PHR), and a PHY payload (PSDU). The PSDU may include a MAC frame. As shown in FIG. 4, the MAC frame may include a MAC header (MHR), a MAC payload and/or a MAC footer (MFR). In an embodiment of the disclosure, the synchronization header part may be referred to as a preamble, and the part including the PHY header and the PHY payload may be referred to as a data part.

The synchronization header may be used for synchronization for signal reception and may include a SY NC field and a start-of-frame delimiter (SFD).

The SY NC field may be a field including a plurality of preamble symbols used for synchronization between transmission/reception devices. The preamble symbol may be set through one of previously defined preamble codes.

The SFD field may be a field indicating the end of the SHR and the start of the data field.

The PHY header may provide information about the configuration of the PHY payload. For example, the PHY header may include information about the length of the PSDU, information indicating whether the current frame is an RFRAME, and the like.

Meanwhile, the PHY layer of the UWB device may include an optional mode to provide a reduced on-air time for high density/low power operation. In this case, the UWB PHY packet may include an encrypted sequence (i.e., STS) to increase the integrity and accuracy of the ranging measurement timestamp. An STS may be included in the STS field of the UWB PHY packet and be used for secure ranging.

Referring to FIG. 5B, in the case of STS packet (SP) setting 0 (SP0), the STS field is not included in the PPDU (SP0 packet). In the case of SP setting 1 (SP1), the STS field is positioned immediately after the start of frame delimiter (SFD) field and before the PHR field (SP1 packet). In the case of SP setting 2 (SP2), the STS field is positioned after the PHY payload (SP2 packet). In the case of SP setting 3 (SP3), the STS field is positioned immediately after the SFD field, and the PPDU does not include the PHR and data field (PHY payload) (SP3 packet). In other words, in the case of SP3, the PPDU does not include the PHR and PHY payload.

In the embodiment of FIG. 5B, each UWB PHY packet may include RMARKER for defining a reference time. RMARKER may be used to obtain the transmission time, reception time and/or time range of the ranging message (frame) in the UWB ranging procedure.

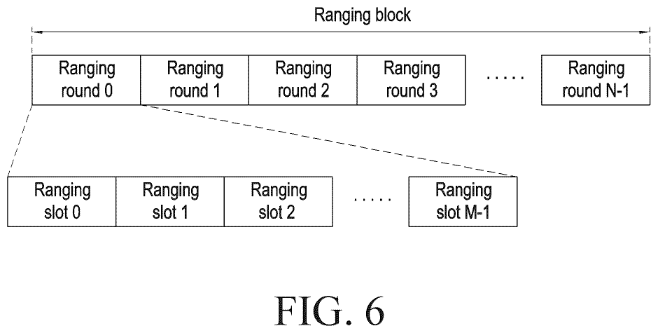

FIG. 6 illustrates a structure of a ranging block and round used for UWB ranging according to an embodiment of the disclosure.

In an embodiment of the disclosure, the ranging block refers to a time period for ranging. The ranging round may be a period of sufficient duration to complete one entire range-measurement cycle (ranging cycle) in which a set of UWB devices participating in a ranging exchange involves. The ranging slot may be a sufficient period for transmission of at least one ranging frame (RFRAME) (e.g., ranging initiation/reply/final message, or the like).

Referring to FIG. 6, one ranging block may include at least one ranging round. Each ranging round may include at least one ranging slot.

When the ranging mode is a block-based mode, a mean time between contiguous ranging rounds may be a constant. Alternatively, when the ranging mode is an interval-based mode, the time between contiguous ranging rounds may be dynamically changed. In other words, the interval-based mode may adopt a time structure having an adaptive spacing.

The number and duration of slots included in the ranging round may be changed between ranging rounds.

In an embodiment of the disclosure, a ranging block, a ranging round, and a ranging slot may be abbreviated as a block, a round, and a slot.

A UWB session may be used for contention-based ranging (CBR), double-sided two-way ranging (DS-TWR), in-band data transfer (IDT), hybrid UWB session (HUS), or downlink-time difference of arrival ranging (DL-TDoA).

In a session for CBR, a controller device and a controlee device perform single-sided two-way ranging (SS-TWR), in which the controller device can discover the controlee device and measure the distance, MAC address, and angle of arrival (AoA) of the controlee. However, the controlee device cannot determine the distance information.

In a session for DS-TWR, the controller and the controlee devices may measure the distance and AoA with each other during a contention-free period (CFP). In such a session, data transmission through data piggybacking may also be possible.

A session for IDT is used for data transmission, and may exchange information used for a transaction by establishing a secure channel.

The HUS may manage multiple sessions by grouping them into a primary session, and multiple secondary phases may be created within the primary session.

In a session for DL-TDoA, multiple anchors receive signals from a single tag and measure the time difference of arrival (TDoA) of the signals received at each anchor. Since these time differences vary depending on the propagation speed of the radio signals, the location of the tag can be estimated using such differences. The position estimation can be performed based on the relative positions of the anchors and the distances between the tag and the anchors. In a DL-TDoA session, the location may be calculated internally within the device, which may enhance security.

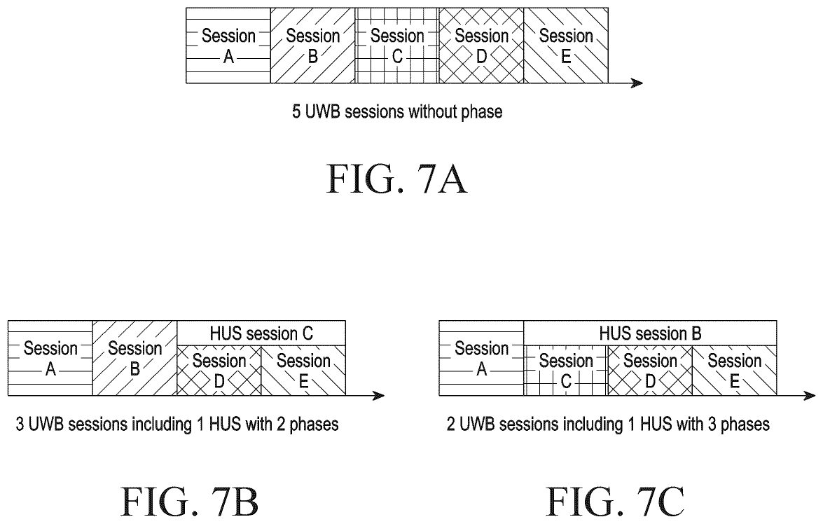

FIGS. 7A, 7B, and 7C illustrate a UWB session configurations according to various embodiments of the disclosure.

FIGS. 7A, 7B, and 7C illustrate three different examples of UWB session configurations using HUS and phases.

FIG. 7A illustrates a configuration of five standard UWB sessions without using phases. A total of five independent UWB sessions (A through E) are sequentially executed, and each session may exist independently without a HUS or any phases. In this case, although the resource utilization is relatively low, the configuration is simple.

FIG. 7B illustrates a session configuration including two standard sessions and one HUS session (a total of three sessions). Session A and Session B are standard UWB sessions, and Session C is a HUS session which may include internal phases D and E. For example, multiple tasks may be processed within a single HUS session through multiple phases. In this case, five tasks can be processed using only three sessions.

FIG. 7C illustrates an example of a session configuration including one standard session and one HUS session (a total of two sessions). Session A may be a standard UWB session, and Session B may be a HUS session consisting of phases C, D, and E. By including as many phases as possible in a single HUS session, resources can be used efficiently. In this case, multiple tasks can be performed with the minimum number of sessions.

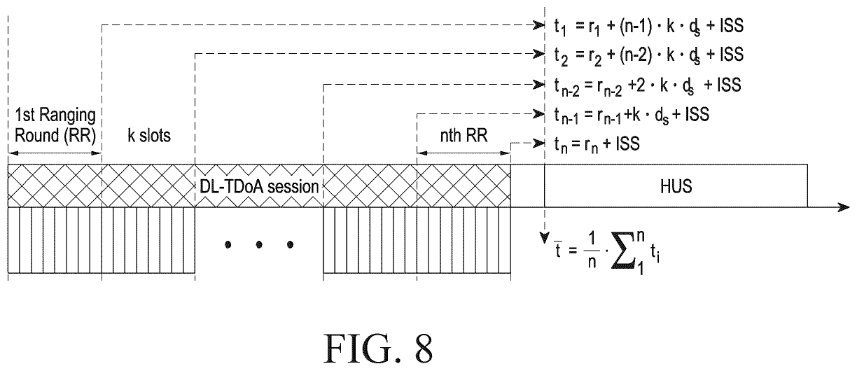

FIG. 8 is a diagram illustrating a DL-TDoA session and a hybrid UWB session according to an embodiment of the disclosure.

FIG. 8 illustrates a method for calculating an accurate synchronization time to start a hybrid UWB session (HUS) following a UWB-based DL-TDoA session. The DL-TDoA session is including multiple ranging rounds (RRs), each of which includes a fixed number of slots. In a contactless gate system (CLT), a UWB device may calculate the average time to start HUS based on the report timings of each RR.

According to an embodiment of the disclosure, the UWB device may calculate an estimated starting time ti at the i-th RR based on Equation 1 below. Each RR may include a fixed number of slots k, during which messages are exchanged, and a ranging report may be generated at the end of each RR.

$${t}_{i} = {r}_{i} + ( n - i ) \cdot k \cdot {d}_{s} + ISS \qquad Equation 1$$

rᵢ: the reception time of the ranging report in the ith RR,
n: the total number of RRS,
k: the number of slots in each RR,
dₛ: the duration of a single slot,
ISS: the inter-session space.

According to an embodiment of the disclosure, the UWB device may calculate the HUS starting time (t) by averaging the ti values calculated for each RR based on Equation 2 below.

$$\overline{t} = \frac{1}{n} {\sum }_{i = 1}^{n} {t}_{i} \qquad Equation 2$$

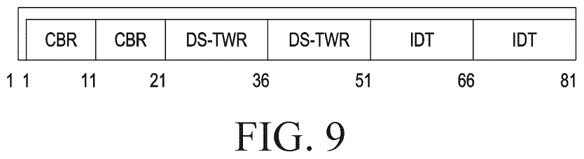

FIG. 9 illustrates a hybrid UWB session configuration according to an embodiment of the disclosure.

Referring to FIG. 9, when two UWB gates exist and each UWB device operates as an initiator device within a secondary phase, the hybrid UWB session (HUS) may be configured to support two initiator devices simultaneously. The HUS may include one primary session acting as a container, two sessions for contention-based ranging (CBR) (e.g., 10*2 ms), two sessions for double-sided two-way ranging (DS-TWR) (e.g., 15*2 ms), and two sessions for in-band data transfer (IDT) (e.g., 15*2 ms).

The HUS may enable synchronization of time between different UWB devices and facilitate coordinated session operation. However, as the number of UWB devices acting as initiators and the number of phases increases when using HUS, the length of a single block may become longer, and all sessions may need to operate on the same channel.

Referring to FIG. 9, in order to support two initiator devices simultaneously, the HUS requires at least seven sessions (i.e., one primary session+two CBR sessions+two DS-TWR sessions+two IDT sessions). However, due to hardware implementation constraints, the HUS may be implemented to include only four sessions (i.e., one primary session and three secondary sessions).

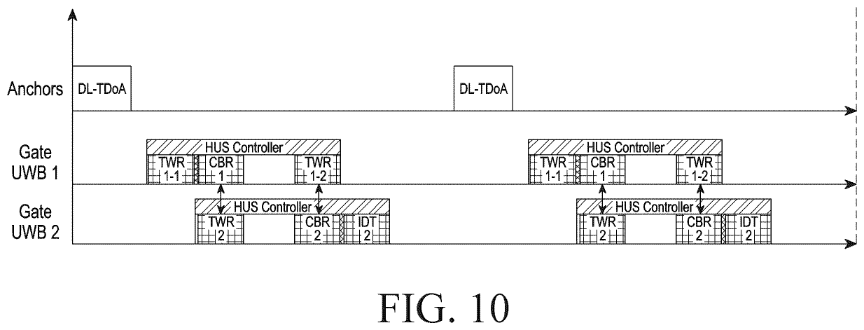

FIG. 10 is a diagram illustrating a possibility of interference due to a multi-session configuration according to an embodiment of the disclosure.

Referring to FIG. 10, multiple DL-TDoA sessions for anchors, multiple hybrid UWB sessions (HUSs) for a first UWB gate (Gate UWB 1), and multiple HUSs for a second UWB gate (Gate UWB 2) may be configured. When utilizing HUS, up to three secondary phases may be generated within a primary. Scheduling of secondary phases may be configured within the UWB chipset.

The anchors may estimate a position in a DL-TDoA session by using the time differences at which wireless signals or other types of waves arrive. The HUS for Gate UWB 1 may include a primary that acts as a container, an HUS controller, two phases for TWR (TWR 1-1 and TWR 1-2), and a phase for CBR (CBR 1). The HUS for Gate UWB 2 may include a primary that acts as a container, an HUS controller, a phase for TWR (TWR 2), a phase for CBR (CBR 2), and a phase for IDT (IDT 2).

However, as illustrated in FIG. 10, communication interference may occur between CBR 1 of Gate UWB 1 and TWR 2 of Gate UWB 2 due to overlapping time intervals. Likewise, interference may occur between TWR 1-2 of Gate UWB 1 and CBR 2 of Gate UWB 2 when their time intervals overlap.

The disclosure proposes a method of scheduling the UWB sessions (or phases in sessions) of Gate UWB 1 and Gate UWB 2 so that their time intervals do not overlap, thereby reducing communication interference.

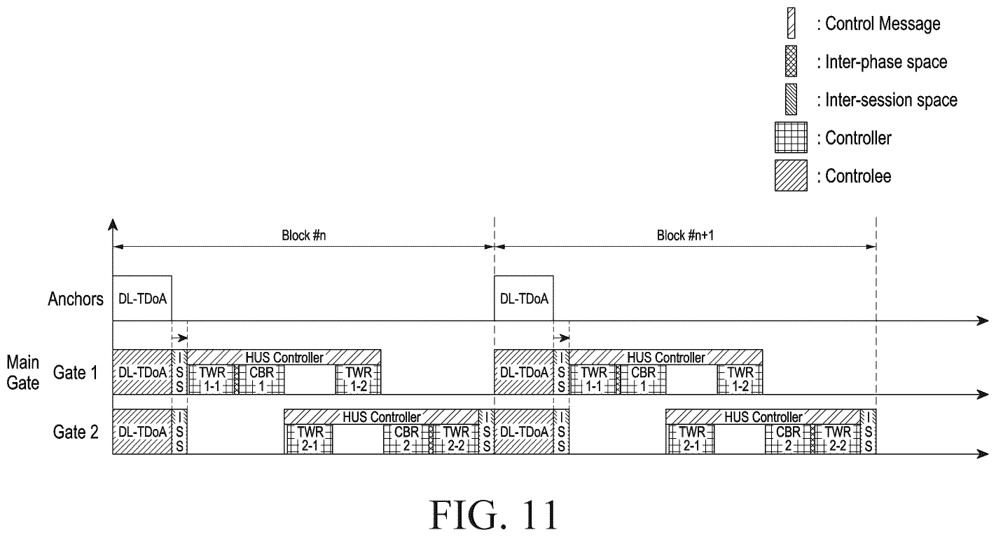

FIG. 11 illustrates UWB devices configure a multi-session according to an embodiment of the disclosure.

Referring to FIG. 11, in each of block #n and block #n+1, sessions may be configured for DL-TDoA of anchors, DL-TDoA for controlee devices associated with the main gate (Gate UWB 1), a hybrid UWB session (HUS) for Gate UWB 1, DL-TDoA for controlee devices associated with a second gate (Gate UWB 2), and a HUS for Gate UWB 2. When HUS is utilized, up to three secondary phases may be generated within a primary. The scheduling of secondary phases may be configured within a UWB chipset.

An inter-session space (ISS) may be set between the DL-TDoA session for the controlee device associated with Gate UWB 1 and the HUS for Gate UWB 1. Similarly, a time interval equal to or greater than ISS may be set between the DL-TDoA session for the controlee device associated with Gate UWB 2 and the HUS for Gate UWB 2.

In each of block #n and block #n+1, the anchors may estimate positions by using time differences in the arrival of wireless signals or other types of propagation signals in the DL-TDoA sessions.

In each of block #n and block #n+1, the HUS for Gate UWB 1 in each block may include a primary as a container, an HUS controller, two phases for TWR (TWR 1-1 and TWR 1-2), and a phase for CBR (CBR 1). Within the HUS for Gate UWB 1, the first TWR phase (TWR 1-1) and the CBR phase (CBR 1) may be arranged sequentially with an inter-phase space (IPS) between them, and the second TWR phase (TWR 1-2) may be arranged after a specified time interval following the CBR 1 phase. A control message may be transmitted at the start time of the HUS for Gate UWB 1. IPS (inter phase space) may be configured between phases within the HUS.

In each of block #n and block #n+1, the HUS for Gate UWB 2 may also include a primary as a container, an HUS controller, two phases for TWR (TWR 2-1 and TWR 2-2), and a phase for CBR (CBR 2). In this case, the CBR phase (CBR 2) may be arranged after a specified time interval from the first TWR phase (TWR 2-1), and may also be sequentially arranged with the second TWR phase (TWR 2-2) with an IPS interval. A control message may be transmitted at the start time of the HUS for Gate UWB 2, and IPS may be set between phases within the HUS.

Referring to FIG. 11, the sessions for the HUS of Gate UWB 1 and the HUS of Gate UWB 2 are scheduled such that their time intervals do not overlap, thereby minimizing communication interference.

When the state of the anchor or a UWB device transitions from power-off to power-on, synchronization and session generation may be automatically required. Independent sessions may be used for synchronization of multi-sessions and multi-initiators, minimizing software-based delay and scheduling overhead.

Referring to FIG. 11, the DL-TDoA session serves as a reference session for synchronization among devices. According to an embodiment of the disclosure, at least one of the sessions for TWR, CBR, or IDT may serve as the reference session for device synchronization.

Referring to FIG. 11, the CBR phase in the HUS of Gate UWB 1 and the CBR phase in the HUS of Gate UWB 2 are separated in the time domain, which may reduce interference during gate selection communication. The TWR phases within each HUS are also temporally separated, providing sufficient processing time. Furthermore, minimizing IPS within each HUS helps conserve time resources.

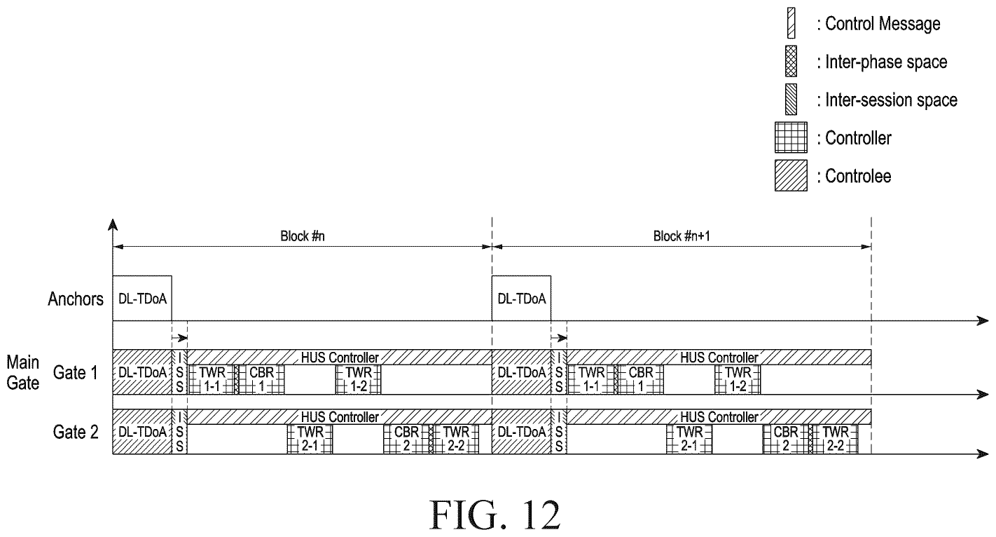

FIG. 12 illustrates UWB devices configure a multi-session according to an embodiment of the disclosure.

Referring to FIGS. 11 and 12, in each of block #n and block #n+1, the following sessions may be configured: a DL-TDoA session for anchors, a DL-TDoA session for a controlee device associated with the main gate (Gate UWB 1), a hybrid UWB session (HUS) for Gate UWB 1, a DL-TDoA session for a controlee device associated with a second gate (Gate UWB 2), and a HUS for Gate UWB 2.

In each of block #n and block #n+1, the HUS for Gate UWB 1 may include a primary acting as a container, an HUS controller, two phases for TWR (TWR 1-1 and TWR 1-2), and a phase for CBR (CBR 1). A control message may be transmitted at the start of the HUS for Gate UWB 1. Referring to FIG. 12, the HUS controller within the HUS for Gate UWB 1 may be configured to extend to the end of both block #n and block #n+1.

In each of block #n and block #n+1, the HUS for Gate UWB 2 may include a primary acting as a container, an HUS controller, two phases for TWR (TWR 2-1 and TWR 2-2), and a phase for CBR (CBR 2). A control message may be transmitted at the start of the HUS for Gate UWB 2. Inter-phase space (IPS) may be set between phases within the HUS for Gate UWB 2. Referring to FIG. 12, the HUS controller within the HUS for Gate UWB 2 may also be configured to extend to the end of both block #n and block #n+1.

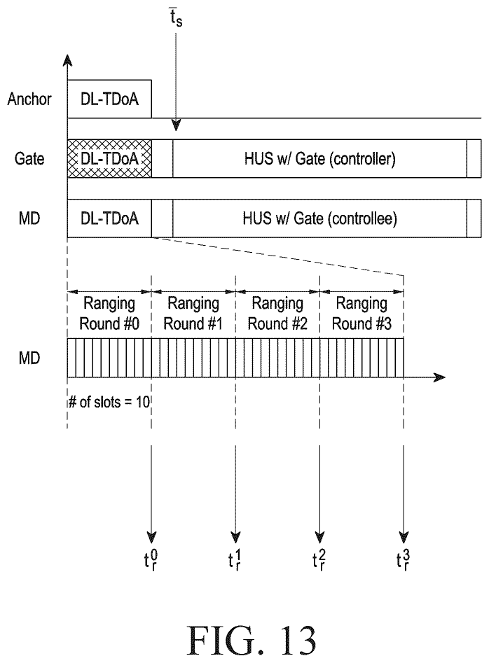

FIG. 13 is a diagram illustrating a timing estimation algorithm (TEA) according to an embodiment of the disclosure.

FIG. 13 illustrates illustrating a timing synchronization structure for a hybrid UWB session (HUS) using the timing estimation algorithm (TEA). Referring to FIG. 13, the alignment of the HUS start timing (t̅ₛ) between a UWB gate (Gate) and a mobile device (MD) after DL-TDoA-based ranging is shown. The UWB gate may serve as a controller that manages UWB sessions, while the M D may act as a controlee and perform the HUS together with the gate.

Referring to FIG. 13, sessions may be configured for the anchor's DL-TDoA, the UWB gate's DL-TDoA, the HUS for the UWB gate, the mobile device's DL-TDoA, and the HUS for the mobile device.

The DL-TDoA session for the MD may include four ranging rounds (Ranging Round #0 to #3), each consisting of 10 slots. The M D may measure the system time at each ranging round

$$( e . g . , {t}_{r}^{0} , {t}_{r}^{1} , {t}_{r}^{2} , {t}_{r}^{3} ) .$$

According to one embodiment of the disclosure, a first UWB device may estimate the HUS open timing as the time of the nth ranging round plus the inter-session space (ISS). The first UWB device may calculate the system time

$$( {t}_{s}^{i} )$$

at which the HUS start function should be invoked based on Equation 3.

$${t}_{s}^{i} = {t}_{r}^{i} + ( N - i ) * {D}_{r} + ISS - {jitter}_{OS} \qquad Equation 3$$

$${t}_{i}^{r} :$$

system time when the i-th ranging report is called,
N=0, 1, 2, 3,
D: duration of a ranging round in DL-TDoA,
jitter_{OS}: OS-level jitter compensation value.

The first UWB device may then calculate the average system time (t̅ₛ) at which the HUS start function should be called based on the system time

$$( {t}_{s}^{i} )$$

### and Equation 4.

$${\overline{t}}_{s} = {\sum }_{i = 0}^{N} {t}_{s}^{i} / n \qquad Equation 4$$

In another embodiment of the disclosure, a second UWB device may estimate the HUS open timing by overhearing the previous HUS of the first UWB device. The second UWB device may consider the n-th ranging round time, ISS, k-inter-phase spaces (IPS), and k-session durations (i.e., nth ranging round+ISS+k IPS+k session duration) to estimate the HUS open timing. The second UWB device may calculate the system time

$$( {t}_{s}^{i} )$$

at which the HUS start function should be invoked based on Equation 5.

$${t}_{s}^{i} = {t}_{r}^{i} + ( N - i ) * {D}_{r} + ISS + k * ( ISP + {t}_{d} ) - {jitter}_{OS} \qquad Equation 5$$

$${t}_{r :}^{i}$$

system time of the i-th ranging report,
N=0, 1, 2, 3
Dᵣ: duration of a ranging round in DL-TDoA,
t_{d}: phase duration of the HUS,
jitter_{OS}: OS-level jitter compensation value.

The second UWB device may then calculate the average system time (t̅ₛ) at which the HUS start function should be called based on the system time

$$( {t}_{s}^{i} )$$

### Equation 6.

$${\overline{t}}_{s} = {\sum }_{i = 0}^{n} {t}_{s}^{i} / n \qquad Equation 6$$

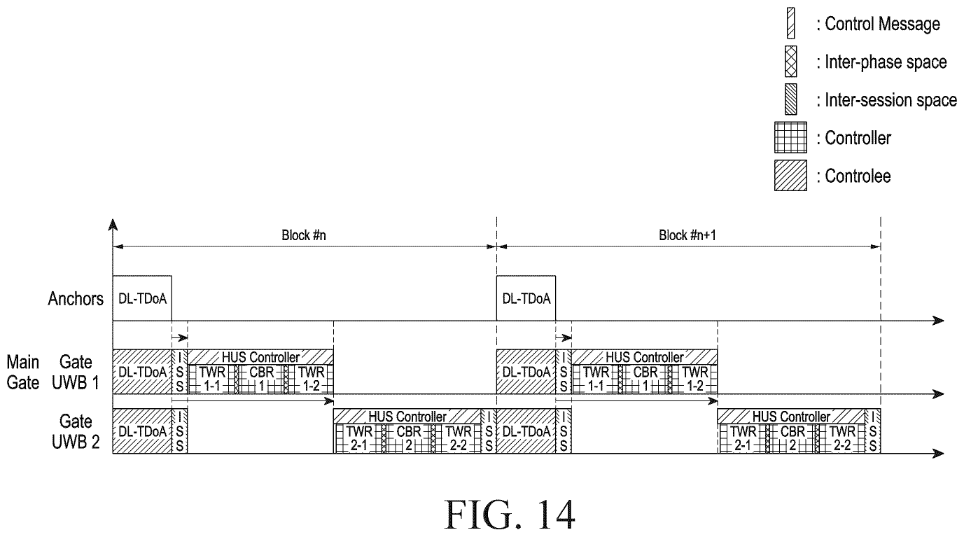

FIG. 14 illustrates a UWB devices configure a multi-session according to an embodiment of the disclosure.

Referring to FIG. 14, in each of block #n and block #n+1, the following sessions may be configured: a DL-TDoA session for anchors, a DL-TDoA session for the main gate (Gate UWB 1), a hybrid UWB session (HUS) for Gate UWB 1, a DL-TDoA session for Gate UWB 2, and a HUS for Gate UWB 2. When HUS is utilized, up to three secondary phases may be created within a primary. The scheduling of secondary phases may be configured within the UWB chipset.

An inter-session space (ISS) may be set between the DL-TDoA session for the controlee device associated with Gate UWB 1 and the HUS for Gate UWB 1. Similarly, a time interval equal to or greater than ISS may be set between the DL-TDoA session for the controlee device associated with Gate UWB 2 and the HUS for Gate UWB 2.

In each of block #n and block #n+1, the anchors may estimate a position in the DL-TDoA session based on the time differences in the arrival of wireless signals or other types of propagation signals.

In each of block #n and block #n+1, the HUS for Gate UWB 1 may include a primary as a container, an HUS controller, two phases for TWR (TWR 1-1 and TWR 1-2), and a phase for CBR (CBR 1). Within the HUS for Gate UWB 1, the first TWR phase (TWR 1-1), the CBR phase (CBR 1), and the second TWR phase (TWR 1-2) may be sequentially arranged with inter-phase spaces (IPS) between them.

Similarly, in each of block #n and block #n+1, the HUS for Gate UWB 2 may include a primary as a container, an HUS controller, two phases for TWR (TWR 2-1 and TWR 2-2), and a phase for CBR (CBR 2). Within the HUS for Gate UWB 2, the first TWR phase (TWR 2-1), the CBR phase (CBR 2), and the second TWR phase (TWR 2-2) may also be sequentially arranged with IPS intervals.

The scheduling method illustrated in FIG. 14 has the advantage of a shorter HUS length, which makes it easier to allocate longer processing time before the next block. However, it may also have a draw back in that the short intervals between TWR phases within the HUS can limit the available processing time, and the IPS placement may consume additional time resources.

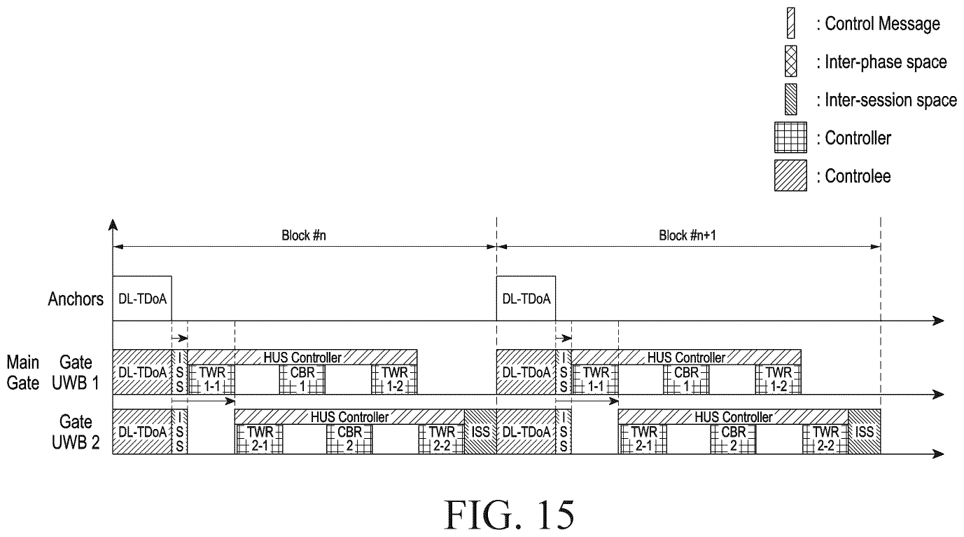

FIG. 15 illustrates UWB devices configure a multi-session according to an embodiment of the disclosure.

Referring to FIG. 15, in each of block #n and block #n+1, the following sessions may be configured: a DL-TDoA session for anchors, a DL-TDoA session for the main gate (Gate UWB 1), a hybrid UWB session (HUS) for Gate UWB 1, a DL-TDoA session for Gate UWB 2, and a HUS for Gate UWB 2. When HUS is utilized, up to three secondary phases may be created within a primary. The scheduling of secondary phases may be configured within a UWB chipset.

An inter-session space (ISS) may be set between the DL-TDoA session for the controlee device associated with Gate UWB 1 and the HUS for Gate UWB 1. Similarly, a time interval equal to or greater than ISS may be set between the DL-TDoA session for the controlee device associated with Gate UWB 2 and the HUS for Gate UWB 2.

In each of block #n and block #n+1, the anchors may estimate a position in the DL-TDoA session using time differences in the arrival of wireless signals or other types of propagation.

In each of block #n and block #n+1, the HUS for Gate UWB 1 may include a primary as a container, an HUS controller, two phases for TWR (TWR 1-1 and TWR 1-2), and a phase for CBR (CBR 1). Within the HUS for Gate UWB 1, the CBR phase (CBR 1) may be scheduled after a predefined time interval from the first TWR phase (TWR 1-1), and the second TWR phase (TWR 1-2) may be scheduled after a predefined time interval from the CBR phase (CBR 1).

Similarly, in each of block #n and block #n+1, the HUS for Gate UWB 2 may include a primary as a container, an HUS controller, two phases for TWR (TWR 2-1 and TWR 2-2), and a phase for CBR (CBR 2). The CBR phase (CBR 2) may be scheduled after a predefined time interval from the first TWR phase (TWR 2-1), and the second TWR phase (TWR 2-2) may be scheduled after a predefined time interval from the CBR phase (CBR 2).

The scheduling method illustrated in FIG. 15 has the advantage that sufficient processing time can be ensured due to the wide spacing between TWR phases within the HUS, and that time resources can be conserved as no inter-phase space (IPS) is required. However, it also has the draw back that the HUS occupies a long time span, leaving limited available time before the next block, and communication interference may occur between the CBR phases (CBR 1 and CBR 2).

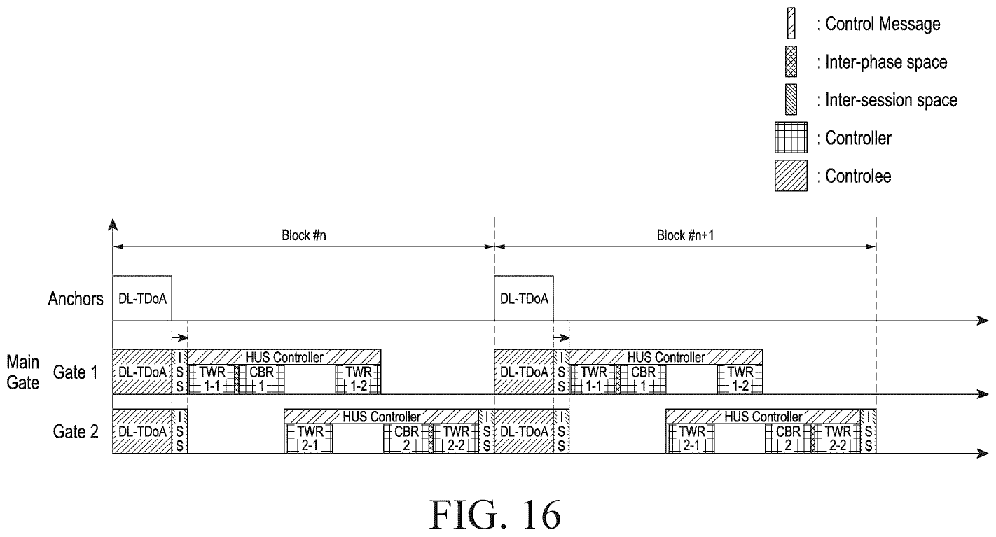

FIG. 16 illustrates UWB devices configure a multi-session according to an embodiment of the disclosure.

Referring to FIG. 16, in each of block #n and block #n+1, the following sessions may be configured: a DL-TDoA session for anchors, a DL-TDoA session for the main gate (Gate UWB 1), a hybrid UWB session (HUS) for Gate UWB 1, a DL-TDoA session for Gate UWB 2, and a HUS for Gate UWB 2.

In each of block #n and block #n+1, the HUS for Gate UWB 1 may include a primary acting as a container, an HUS controller, two phases for TWR (TWR 1-1 and TWR 1-2), and a phase for CBR (CBR 1). Within the HUS for Gate UWB 1, the CBR phase (CBR 1) may be scheduled after an inter-phase space (IPS) from the first TWR phase (TWR 1-1), and the second TWR phase (TWR 1-2) may be scheduled after a predefined time interval from the CBR phase (CBR 1).

Similarly, in each of block #n and block #n+1, the HUS for Gate UWB 2 may include a primary acting as a container, an HUS controller, two phases for TWR (TWR 2-1 and TWR 2-2), and a phase for CBR (CBR 2). Within the HUS for Gate UWB 2, the CBR phase (CBR 2) may be scheduled after a predefined time interval from the first TWR phase (TWR 2-1), and the second TWR phase (TWR 2-2) may be scheduled after an IPS interval from the CBR phase (CBR 2).

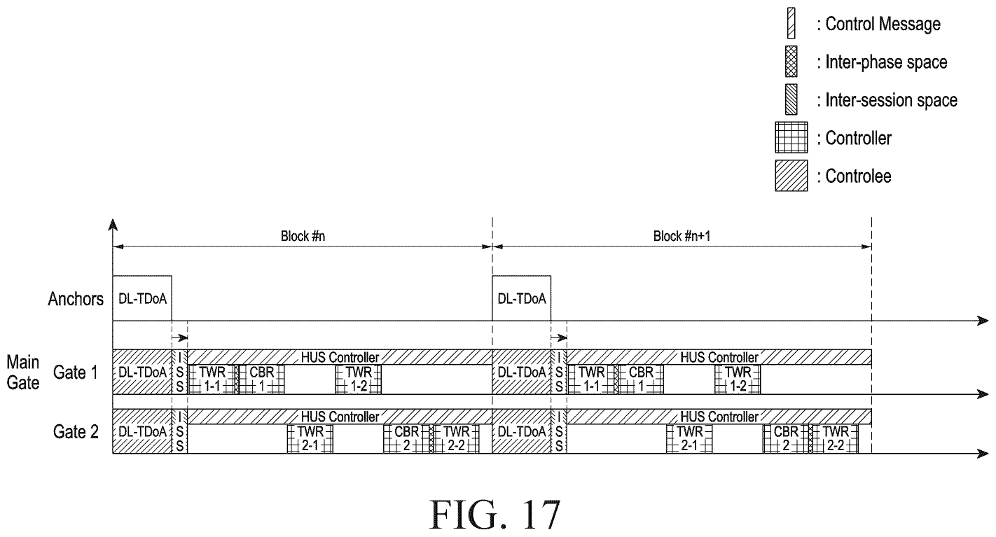

FIG. 17 illustrates UWB devices configure a multi-session according to an embodiment of the disclosure.

Referring to FIG. 17, in each of block #n and block #n+1, the HUS for the first UWB gate (Gate UWB 1) may include a primary acting as a container, an HUS controller, two phases for TWR (TWR 1-1 and TWR 1-2), and a phase for CBR (CBR 1). Within the HUS for Gate UWB 1, the CBR phase (CBR 1) may be scheduled after an inter-phase space (IPS) from the first TWR phase (TWR 1-1), and the second TWR phase (TWR 1-2) may be scheduled after a predefined time interval from the CBR phase. The HUS controller for Gate UWB 1 in FIG. 17 may be configured to extend to the end of both block #n and block #n+1.

In each of block #n and block #n+1, the HUS for the second UWB gate (Gate UWB 2) may include a primary acting as a container, an HUS controller, two phases for TWR (TWR 2-1 and TWR 2-2), and a phase for CBR (CBR 2). Within the HUS for Gate UWB 2, the CBR phase (CBR 2) may be scheduled after a predefined time interval from the first TWR phase (TWR 2-1), and the second TWR phase (TWR 2-2) may be scheduled after an IPS interval from the CBR phase (CBR 2). The HUS controller for Gate UWB 2 in FIG. 17 may also be configured to extend to the end of both block #n and block #n+1.

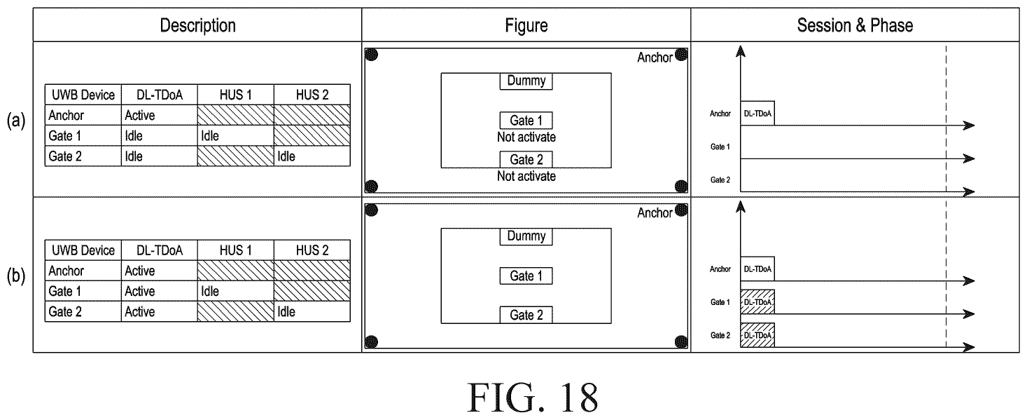

FIGS. 18, 19, 20, and 21 illustrate changes in session and phase configurations by block in a UWB tagless gate scenario according to various embodiments of the disclosure.

Referring to part (a) of FIG. 18, the anchor is in an active state for the DL-TDoA session, while both Gate 1 and Gate 2 are in an Idle state for the DL-TDoA session. Gate 1 and Gate 2 are also in an Idle state for their respective HUS sessions (HUS 1, HUS 2). In this state, the HUS sessions of Gate 1 and Gate 2 may be in a pre-start state, with the session open already completed.

Referring to part (b) of FIG. 18, the anchor, Gate 1, and Gate 2 are all in an Active state for the DL-TDoA session. Gate 1 and Gate 2 remain Idle in their respective HUS sessions (HUS 1, HUS 2). In this state, Gate 1 and Gate 2 may participate as tags (controlees) in the DL-TDoA session.

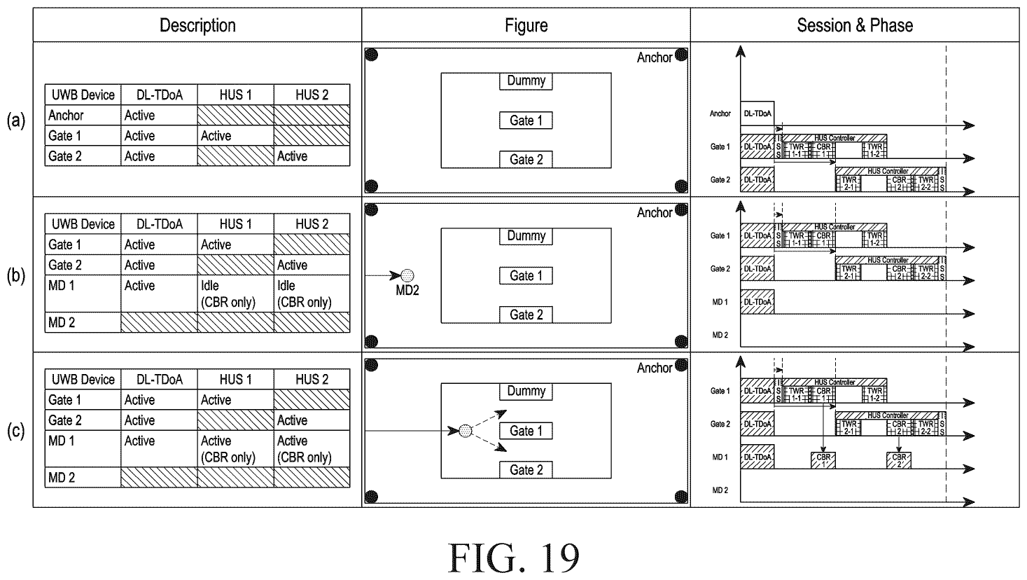

Referring to part (a) of FIG. 19, the anchor, Gate 1, and Gate 2 are in an Active state for the DL-TDoA session. Gate 1 is Active in HUS 1, and Gate 2 is Active in HUS 2. HUS 1 may include a primary, an HUS controller, two TWR phases (TWR 1-1, TWR 1-2), and one CBR phase (CBR 1). HUS 2 may include a primary, an HUS controller, two TWR phases (TWR 2-1, TWR 2-2), and one CBR phase (CBR 2).

Referring to part (b) of FIG. 19, Gate 1, Gate 2, and mobile device 1 (M D 1) are Active in the DL-TDoA session. Gate 1 is Active in HUS 1. Gate 2 is Active in HUS 2. MD 1 is Idle (CBR Only) in both HUS 1 and HUS 2. MD 1 may participate in the DL-TDoA session, and the CBR phases (CBR 1, CBR 2) for gate selection may be open.

Referring to part (c) of FIG. 19, Gate 1, Gate 2, and MD 1 are Active in the DL-TDoA session. Gate 1 and Gate 2 are Active in their respective HUS sessions. MD 1 remains Idle (CBR Only) in both HUS 1 and HUS 2. MD 1 may enter the Gate Access A rea.

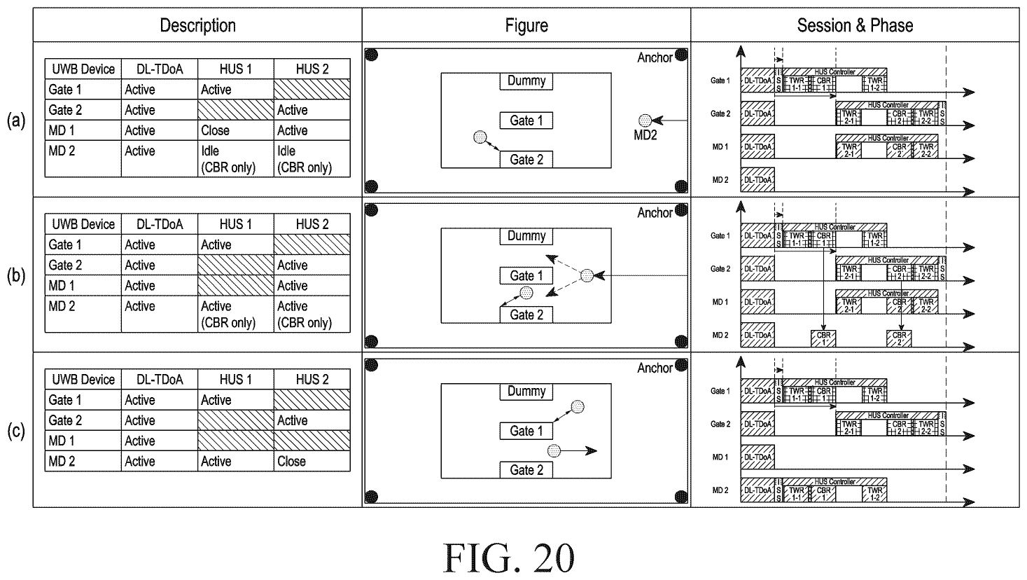

Referring to part (a) of FIG. 20, Gate 1, Gate 2, M D 1, and mobile device 2 (M D 2) are all Active in the DL-TDoA session. In HUS 1: Gate 1 is Active, MD 1 is Closed, and M D 2 is Idle (CBR Only). In HUS 2: Gate 2 is Active, M D 1 is Active, and MD 2 is Idle (CBR Only). MD 1 may select Gate 2. M D 2 may participate in DL-TDoA and its CBR phases (CBR 1, CBR 2) may be open for gate selection.

Referring to part (b) of FIG. 20, Gate 1, Gate 2, MD 1, and MD 2 are Active in the DL-TDoA session. In HUS 1: Gate 1 is Active, and M D 2 is Active (CBR Only). In HUS 2: Gate 2 is Active, MD 1 is Active, and M D 2 is Active (CBR Only). MD 1 may pass between Gate 1 and Gate 2, and M D 2 may enter the Gate Access Area.

Referring to part (c) of FIG. 20, Gate 1, Gate 2, MD 1, and MD 2 are Active in the DL-TDoA session. In HUS 1: Gate 1 is Active, and M D 2 is Active (CBR Only). In HUS 2: Gate 2 is Active, and M D 2 is Closed. In this case, M D 1 may complete its HUS session, and M D 2 may select Gate 1.

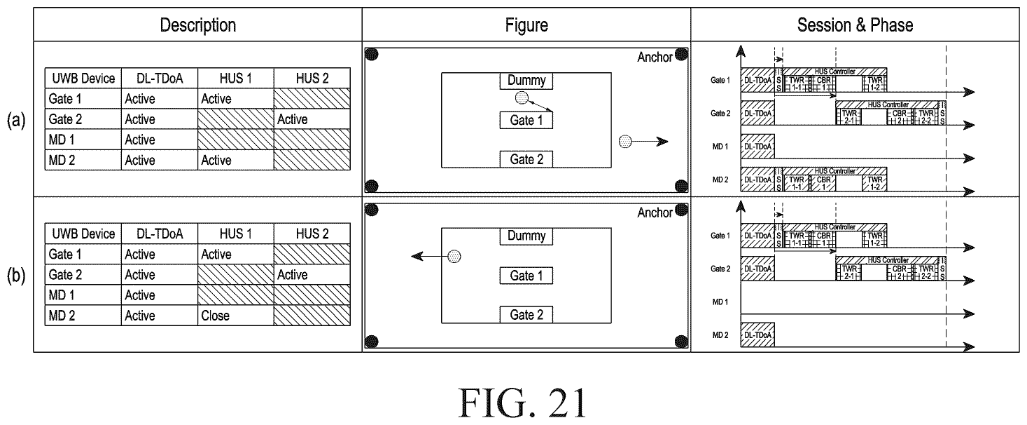

Referring to part (a) of FIG. 21, Gate 1, Gate 2, MD 1, and MD 2 are Active in the DL-TDoA session. In HUS 1: Gate 1 is Active, and M D 2 is Active (CBR Only). In HUS 2: Gate 2 is Active. In this case, M D 2 may pass through Gate 1.

Referring to part (b) of FIG. 21, Gate 1, Gate 2, MD 1, and MD 2 are Active in the DL-TDoA session. In HUS 1: Gate 1 is Active, and M D 2 is Closed. In HUS 2: Gate 2 is Active. In this case, MD 2 may pass through the DL-TDoA area of MD 1 and complete its HUS session.

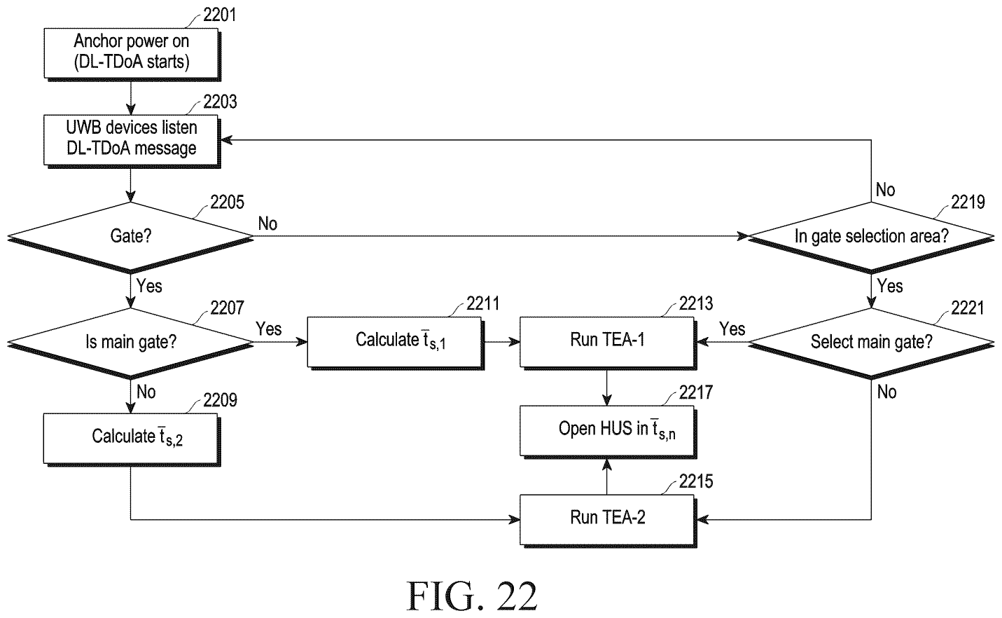

FIG. 22 is a flowchart illustrating an operation of a UWB device according to an embodiment of the disclosure.

Referring to FIG. 22, in operation 2201, an anchor that provides network timing may power on the device and broadcast a DL-TDoA message. In operation 2203, UWB devices may listen to the DL-TDoA message. In operation 2205, if the UWB device is a gate (operation 2205—yes), then in operation 2207, the UWB device may determine whether it is the main gate. If the UWB device is not the main gate (operation 2207—no), then in operation 2209, the UWB device may calculate the average system time (t̅_{s,2}) at which the HUS start function should be invoked. If the UWB device is the main gate (operation 2207—yes), then in operation 2211, the UWB device may calculate the average system time (t̅_{s,1}), at which the HUS start function should be invoked.

In operation 2213, the UWB device may execute a first timing estimation algorithm (TEA-1) based on Equations 3 and 4. In operation 2215, the UWB device may execute a second timing estimation algorithm (TEA-2) based on Equations 5 and 6. In operation 2217, the UWB device may open the HUS at the average system time (t̅_{s,n}) when the HUS start function is to be invoked.

If the UWB device is not a gate (operation 2205—no), then in operation 2219, the UWB device may determine whether it is located within a gate selection area. If the UWB device is in the gate selection area (operation 2219—yes), then in operation 2221, the UWB device may decide whether to select the main gate. If the UWB device selects the main gate (operation 2221—yes), then in operation 2213, it may execute TEA-1 based on Equations 3 and 4. If the UWB device does not select the main gate (operation 2221—no), then in operation 2215, it may execute TEA-2 based on Equations 5 and 6.

If the UWB device is not in the gate selection area (operation 2219—no), then it may proceed back to operation 2203 to receive the DL-TDoA message.

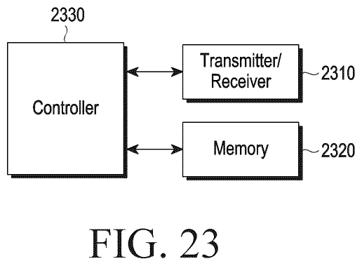

FIG. 23 illustrates a structure of a UWB device according to an embodiment of the disclosure.

Referring to FIG. 23, the UWB device may include a transceiver 2310, memory 2320, and a controller 2330.

The transceiver 2310, the controller 2330, and the memory 2320 of the UWB device may be operated according to the above-described UWB device communication method. However, the components of the UWB device are not limited thereto. For example, the UWB device may include more or fewer components than the above-described components. The transceiver 2310, the controller 2330, and the memory 2320 may be implemented in the form of a single chip. The controller 2330 may include one or more processors.

The transceiver 2310 collectively refers to a transmitter of the UWB device and a receiver of the UWB device and may transmit and receive signals to/from another device. To that end, the transceiver 2310 may include a radio frequency (RF) transmitter for frequency-up converting and amplifying signals transmitted and an RF receiver for low-noise amplifying signals received and frequency-down converting the frequency of the received signals. However, this is merely an embodiment of the transceiver 2310, and the components of the transceiver 2310 are not limited to the RF transmitter and the RF receiver.

The transceiver 2310 may receive signals via a radio channel, output the signals to the controller 2330, and transmit signals output from the controller 2330 via a radio channel.

The memory 2320 may store programs and data necessary for the operation of the UWB device. The memory 2320 may store control information or data that is included in the signal obtained by the UWB device. The memory 2320 may include a storage medium, such as read only memory (ROM), random access memory (RAM), hard disk, compact disc (CD)-ROM, and digital versatile disc (DVD), or a combination of storage media. Rather than being separately provided, the memory 2320 may be embedded in the controller 2330.

The controller 2330 may control a series of processes for the UWB device to be able to operate according to the above-described embodiments.

The controller 2330 is configured to: receive a downlink time difference of arrival (DL-TDoA) message from an anchor in a session for DL-TDoA; control performance of contention-based ranging (CBR) to select a gate for performing UWB ranging in a first HUS of a first gate and a second HUS of a second gate; select the second gate as the gate for performing the UWB ranging based on a result of the CBR; control performance of two-way ranging (TWR) with the second gate in the second HUS of the second gate; and schedule secondary phases in a primary session of the first HUS not to overlap, in terms of time interval, with secondary phases in a primary session of the second HUS.

According to an embodiment, the first HUS includes a first HUS controller session and the secondary phases, and the second HUS includes a second HUS controller session and the secondary phases.

According to an embodiment, the secondary phases of the first and second HUS each include a first TWR phase, a second TWR phase, and a CBR phase.

According to an embodiment, the first HUS controller session in the first HUS and the second HUS controller session in the second HUS are scheduled up to a final time interval of a ranging block to which the first and second HUS belong.

According to an embodiment, the first TWR phase and the CBR phase in the first HUS are consecutively scheduled with an IPS (inter phase space) time interval, and the second TWR phase in the first HUS is scheduled after a predetermined time interval from the CBR phase.

According to an embodiment, the CBR phase in the second HUS is scheduled after a predetermined time interval from the first TWR phase, and the CBR phase in the second HUS is consecutively scheduled with the second TWR phase with an IPS time interval.

According to an embodiment, the first TWR phase, the CBR phase, and the second TWR phase in the first HUS are consecutively scheduled with an IPS time interval.

According to an embodiment, the first TWR phase, the CBR phase, and the second TWR phase in the second HUS are consecutively scheduled with an IPS time interval.

According to an embodiment, the CBR phase in the first HUS is scheduled after a predetermined time interval from the first TWR phase, and the second TWR phase in the first HUS is scheduled after a predetermined time interval from the CBR phase.

According to an embodiment, the CBR phase in the second HUS is scheduled after a predetermined time interval from the first TWR phase, and the second TWR phase in the second HUS is scheduled after a predetermined time interval from the CBR phase.

The methods according to the embodiments described in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROM s), magnetic disc storage devices, compact-disc ROM s, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of operating an ultra wide band (UWB) device, the method comprising:
receiving a downlink time difference of arrival (DL-TDoA) message from an anchor in a session for DL-TDoA;
performing contention-based ranging (CBR) to select a gate for performing UWB ranging, in a first hybrid UWB session (HUS) of a first gate and a second HUS of a second gate;
selecting the second gate as the gate for performing the UWB ranging based on a result of the CBR; and
performing two-way ranging (TWR) with the second gate in the second HUS of the second gate,
wherein secondary phases in a primary session of the first HUS are scheduled not to overlap, in terms of time interval, with secondary phases in a primary session of the second HUS.

2. The method of claim 1,
wherein the first HUS includes a first HUS controller session and the secondary phases, and
wherein the second HUS includes a second HUS controller session and the secondary phases.

3. The method of claim 2, wherein the secondary phases of the first and second HUS each include a first TWR phase, a second TWR phase, and a CBR phase.

4. The method of claim 2, wherein the first HUS controller session in the first HUS and the second HUS controller session in the second HUS are scheduled up to a final time interval of a ranging block to which the first and second HUS belong.

5. The method of claim 3,
wherein the first TWR phase and the CBR phase in the first HUS are consecutively scheduled with an inter phase space (IPS) time interval, and
wherein the second TWR phase in the first HUS is scheduled after a predetermined time interval from the CBR phase.

6. The method of claim 5,
wherein the CBR phase in the second HUS is scheduled after a predetermined time interval from the first TWR phase in the second HUS, and
wherein the CBR phase in the second HUS is consecutively scheduled with the second TWR phase with an IPS time interval.

7. The method of claim 3, wherein the first TWR phase, CBR phase, and second TWR phase in the first HUS are consecutively scheduled with an IPS time interval.

8. The method of claim 7, wherein the first TWR phase, CBR phase, and second TWR phase in the second HUS are consecutively scheduled with an IPS time interval.

9. The method of claim 3,
wherein the CBR phase in the first HUS is scheduled after a predetermined time interval from the first TWR phase, and
wherein the second TWR phase is scheduled after a predetermined time interval from the CBR phase.

10. The method of claim 9,
wherein the CBR phase in the second HUS is scheduled after a predetermined time interval from the first TWR phase, and
wherein the second TWR phase is scheduled after a predetermined time interval from the CBR phase.

11. An ultra wide band (UWB) device comprising:
a transceiver;
at least one processor communicatively coupled to the transceiver; and
memory, communicatively coupled to the at least one processor, storing instructions executable by the at least one processor to cause the UWB device to:
receive a downlink time difference of arrival (DL-TDoA) message from an anchor in a session for DL-TDoA,
control performance of contention-based ranging (CBR) to select a gate for performing UWB ranging in a first HUS of a first gate and a second HUS of a second gate,
select the second gate as the gate for performing the UWB ranging based on a result of the CBR, and
control performance of two-way ranging (TWR) with the second gate in the second HUS of the second gate,
wherein secondary phases in a primary session of the first HUS are scheduled not to overlap, in terms of time interval, with secondary phases in a primary session of the second HUS.

12. The UWB device of claim 11,
wherein the first HUS includes a first HUS controller session and the secondary phases, and
wherein the second HUS includes a second HUS controller session and the secondary phases.

13. The UWB device of claim 12, wherein the secondary phases of the first and second HUS each include a first TWR phase, a second TWR phase, and a CBR phase.

14. The UWB device of claim 12, wherein the first HUS controller session in the first HUS and the second HUS controller session in the second HUS are scheduled up to a final time interval of a ranging block to which the first and second HUS belong.

15. The UWB device of claim 13,
wherein the first TWR phase and the CBR phase in the first HUS are consecutively scheduled with an IPS (inter phase space) time interval, and
wherein the second TWR phase in the first HUS is scheduled after a predetermined time interval from the CBR phase.

16. The UWB device of claim 15,
wherein the CBR phase in the second HUS is scheduled after a predetermined time interval from the first TWR phase, and
wherein the CBR phase in the second HUS is consecutively scheduled with the second TWR phase with an IPS time interval.

17. The UWB device of claim 13, wherein the first TWR phase, the CBR phase, and the second TWR phase in the first HUS are consecutively scheduled with an IPS time interval.

18. The UWB device of claim 17, wherein the first TWR phase, the CBR phase, and the second TWR phase in the second HUS are consecutively scheduled with an IPS time interval.

19. The UWB device of claim 13,
wherein the CBR phase in the first HUS is scheduled after a predetermined time interval from the first TWR phase, and
wherein the second TWR phase in the first HUS is scheduled after a predetermined time interval from the CBR phase.

20. The UWB device of claim 19,
wherein the CBR phase in the second HUS is scheduled after a predetermined time interval from the first TWR phase, and
wherein the second TWR phase in the second HUS is scheduled after a predetermined time interval from the CBR phase.
